(19) United States
(12) Patent Application Publication
(10) Pub. No.: US 2003/0113534 A1
(43) Pub. Date: Jun. 19, 2003

(54) Adhesive tape for outdoor use

(75) Inventor: Daniel Poisson, Renfrew (CA)

Correspondence Address: GREENBERG TRAURIG LLP, SUITE 400E, 2450 COLORADO AVENUE, SANTA MONICA, CA, 90404, US

(73) Assignee: Scapa North America

(21) Appl. No.: 10/223,358

(22) Filed: Aug. 19, 2002

Related U.S. Application Data
(60) Provisional application No. 60/313,713, filed on Aug. 20, 2001.

(51) Int. Cl. B32B 7/12; B32B 15/04

(52) U.S. Cl. 428/343

(57) ABSTRACT

Transparent, UV and heat resistant adhesive compositions and associated methods of manufacturing using such compositions are provided. Exemplary methods of use include the utilization of the provided adhesive compositions as part of tape to be used outdoors where UV exposure is high. The present invention also provides a simple one-pass calendering process whereby the UV resistant adhesive compositions may be formed and extruded directly onto tape backing.

### BACKGROUND OF THE INVENTION

### Field of the Invention

The present invention relates generally to tapes utilizing pressure sensitive adhesives (PSAs). More particularly, the present invention relates to a novel tape that utilizes a unique rubber adhesive formulation and method of manufacture. Such tapes are especially well suited for applications in which the tapes are exposed to high levels of ultraviolet (UV) exposure and/or heat.

Tapes that are currently used in high UV exposure applications, such as greenhouse film repair, utilize acrylic adhesives. However, two significant disadvantages of these tapes are that they do not adhere well to low energy surface substrates, such as polyolefinic (ethylene or propylene) based films and are relatively costly to produce. Many applications, including greenhouse film repair, utilize films from this family of polymers.

The manufacturing cost of acrylic coated adhesive tape is high partly due to the relatively high material costs for acrylic monomer combined with the high labor and energy costs of solution based coating. Acrylic adhesives can be cast from solutions of either organic solvents or water emulsion. Solvent-based coatings are most widely used but present both environmental and safety related issues. As a result, water borne acrylics are becoming more popular in tape coating applications but offer no relief to the high cost of manufacture. In addition to the inherent costs associated with the polymer and method of coating, solution or emulsion based coatings require a purchased substrate to serve as the backing material for the tape.

In the alternative, other materials may be used which have improved adhesion to polyolefins and are economically and environmentally preferable to manufacture. For example, a wide range of rubber based adhesives may be used. Historically, however, rubber based adhesives have been found to be sensitive to degradation by UV exposure and/or heat. For example, free double bonds on the natural rubber backbone or in the isoprene portion of styrene based block copolymers (SBC's), such as styrene-isoprene-styrene (SIS) are prone to attack by UV light. Initially, the resulting chain scission renders the adhesive too soft to perform well in most applications. This is particularly problematic if the tape product must be removed from the substrate after use. Soft, partially degraded adhesives cohesively fail and leave residue on the surface upon removal. Subsequently, the free radicals generated in the molecule recombine at random and stiffen the rubber adhesive. This cross-linking reaction of the adhesive results in a drying out of the coating and an eventual irreversible loss of adhesive properties. In the case of the greenhouse film application, tape products that have progressed to this state will begin to flag and with time, fall away from the film surface. As a result, prior art rubber adhesives such as those based on natural rubber and SIS are very limited in their scope of application when exposure to ultraviolet light is a possibility.

Previously, in order to circumvent this problem pigmented adhesives and/or pigmented tape backings have been used to minimize the exposure of UV to the adhesive system. Additionally, fillers such as titanium dioxide or carbon black have been utilized in adhesives and are highly effective in blocking or absorbing damaging UV radiation. The application of such fillers in adhesives found on tapes for outdoor use is exemplified in U.S. Pat. No. 5,686,179. This patent describes carbon black as a filler, colorant, UV light absorber and reinforcing agent in roofing tapes. Although such methods are effective at reducing the breakdown of adhesives due to UV exposure, the tapes that utilize these methods are colored either by their backing or the composition of the adhesive utilized. However, disadvantageously, the use of a colored adhesive and/or backing or fillers in the adhesive prevents a clear tape from being formed, which is highly desirable for many UV sensitive applications, as for greenhouse film seaming and repair for instance.

Therefore, there arises the need for adhesive formulations of tapes that are inexpensive, safe, and environmentally friendly to produce, intrinsically resistant to UV and/or heat degradation, and that can circumvent the need for colored fillers and/or other colored backings and additives to be used. Further, there is a need for adhesive tapes that have good adhesive properties (tacky and high adhesion), flexibility and good holding power relative to previous acrylic based adhesive tapes or natural rubber based tapes, to serve similar and expanded purposes.

### INVENTION SUMMARY

The present invention provides a novel and effective formulation of an adhesive composition that is resistant to UV and/or heat degradation, which may be used in adhesive tape products.

According to one aspect of the invention, there is provided an adhesive tape product having an adhesive composition having at least one component being a polymer with a substantially saturated backbone. Preferably, the at least one component has a level of saturation of the polymer backbone being at least about 90%, and more at least preferably about 95%. Most preferably, the polymer is ethylene propylene diene monomer (EPDM) rubber (100% backbone saturation) or combinations of ethylene propylene diene monomer (EPDM) rubber with other rubbers or thermoplastic elastomers, the combination being idealized to accomplish the invention. Thus, one feature of the invention is an adhesive useful for the formation of a UV resistant tape which is less expensive and has improved adhesive qualities over the other available alternatives discussed above. A further advantage is an adhesive with improved UW resistance over the other available adhesives which are sensitive to UW degradation in the absence of pigments.

Additionally, in some embodiments, the adhesive composition further comprises tackifying resins, plasticizers, sulfur-donor vulcanizing agents, stabilizers and/or other additives to improve the properties of the adhesive composition to accomplish the advantages of this invention, including but not limited to improved shear and cohesive strength of the adhesive compositions used in the tape.

There is also provided a method of manufacturing a tape using a one-pass calendering process by which the adhesive composition is extruded and calendered onto tape backing, for example.

Further, this tape backing can be formed in the same calendering step thus eliminating the need to purchase a preformed film for this purpose. Thus, one feature of the invention is an improved method for manufacturing UW resistant tapes.

Other objects, features and advantages of the present invention will become apparent from a consideration of the following detailed description of preferred embodiments and the accompanying drawings.

### BRIEF DESCRIPTION OF THE DRAWINGS

FIG. 1 is a diagrammatic representation of an adhesive tape having a backing layer and an adhesive layer adhered thereto.

FIG. 2 is a diagrammatic representation of one method of manufacturing adhesive tapes via a one-step process where the backing and adhesive layers are extruded and calendered.

### DETAILED DESCRIPTION OF THE PREFERRED EMBODIMENTS

In the following description of preferred embodiments, reference is made to the accompanying drawings which form the part thereof, and in which are shown by way of illustration of specific embodiments in which the invention can be practiced. It is to be understood that other embodiments can be utilized and structural and functional changes can be made without departing from the scope of the present invention.

Adhesive Composition

According to one embodiment of the present invention, there is provided an adhesive composition for use in the adhesive tape having at least one component being a polymer with a substantially saturated backbone. Preferably, the at least one component has a level of saturation of the polymer backbone being about 90%, and more preferably about 95%. It has been discovered that the saturated backbone of a rubber adhesive, for example, at least imparts excellent stability to the adhesive compositions described herein, and renders these compositions UV resistant without the further addition of pigments. Additionally, improved heat resistance of the adhesive compositions, made in accordance to the teachings of the present invention is due to the at least one component's substantially saturated backbone. Double bonds such as those encountered in polyisoprene (ex. natural rubber or the midblock portion of SIS) are prone to attack by UV as well as oxygen (associated with heat).

Further, it is preferable that the at least one component having a substantially saturated backbone comprise at least about 15% of the adhesive composition. More preferably, the at least one component having a saturated backbone comprises at least about 50% of the adhesive composition. Most preferably, the at least one component having a saturated backbone comprises at least about 75% of the adhesive composition.

One example of a rubber polymer which is preferred for use in the invention and having a substantially saturated backbone is ethylene propylene rubber (EPR). A particularly useful member of the EPR family is ethylene propylene diene monomer (EPDM). EPDM is a terpolymer which is made of ethylene, propylene (for the saturated backbone) and a non-conjugated diene monomer forming the sidechains. Specifically, the EPDM may be Royalene® 301T manufactured by Uniroyal Chemical Company, Inc, Naugatuck, Conn. Typical levels of backbone saturation of EPDM products are about 100% due to the ethylene and propylene monomers used in the manufacture. Most preferably, the EPDM is saturated to a level of over about 98% to about 100%. The saturation provides compounds made in accordance with the teachings of the present invention very good resistance to degradation due exposure to UV, heat and ozone, for example.

Most preferably, the adhesive composition comprises about 50% to 100% EPDM. In some embodiments, the adhesive composition comprises EPDM in combination with other polymer components. The additional polymer components may have a saturated backbone, but need not. The additional polymer component preferably is fully saturated, and more preferably has a substantially saturated backbone (being at least about 90% saturated).

The three comonomers most commonly employed in industry to introduce unsaturation of EPDM polymer sidechains are the following: ethylidene norbomene (ENB), dicyclopentadiene (DCPD), and 1,4 hexadiene (1,4 HD). The unsaturation is advantageous for cross-linking (vulcanization) of a polymer, which has been found to improve the shear resistance (holding power) of the adhesive. Since the unsaturation is not part of the skeleton of the elastomer molecule, the polymer possesses an outstanding resistance to weathering.

Another example of a rubber polymer that may be useful in the invention is polyisobutylene, which also has a substantially saturated backbone. Most preferably, the polyisobutylene is saturated to a level of about 90% to less than about 100%. It cannot however be vulcanized by normal methods because of its saturated hydrocarbon structure. For example, low molecular weight grades may be used as a tack enhancer, while higher molecular weight grades may impart some shear resistance but they are less easy to process.

More specifically, butyl rubber may be used. Butyl rubber is a particular type of polyisobutylene where isoprene comonomer is added in the polymer backbone. Typical levels of backbone saturation of butyl rubber products are about 95 to about 98%.

This unsaturation is useful for cross-linking, however the carbon double bonds are prone to degradation (UV, oxygen or ozone). Butyl based adhesives are nevertheless more resistant to degradation than natural rubber based adhesives because the unsaturation level is substantially lower.

However, butyl rubber and its halogenated derivatives are less resistant to degradation than EPDM since the unsaturation is part of the backbone of the polymer. Thus, EPDM is preferred over butyls. Commercially, even if the price of EPDM per pound is slightly more than butyl rubber in general, the lower density of EPDM (0.86 g/cm³) over butyl rubber (0.92 g/cm³) tends to offset the cost disadvantage.

In some embodiments, the adhesive composition comprises about 0-100% polyisobutylene. For example, the adhesive composition may comprise about 20 to about 80 percent EPDM and about 80 to about 20 percent polyisobutylene. More specifically, the adhesive composition may comprise about 75% EPDM and about 25% polyisobutylene.

Thermoplastic elastomers may be additionally useful components in the adhesive of this invention. By opposition to conventional rubbers they do not need to be vulcanized to provide the full properties of cohesive strength (holding power). Types of commercially important thermoplastic elastomers which may be used in the invention, include but are not limited to: 1) polystyrene/elastomer block copolymers; 2) polyester block copolymers; 3) polyurethane block copolymers; 4) polyamide block copolymers and 5) polypropylene/EP copolymer blends.

Preferably, thermoplastic elastomers are used in combination with at least one of the rubber polymers described above to form the adhesive composition. Thermoplastic elastomers may be added to improve the performance of the rubber polymers including, but not limited to improved shear and cohesive strength. For example, the adhesive composition may comprise about 20 to about 80 percent rubber polymer and about 20 to about 80 percent thermoplastic elastomer. More specifically, the adhesive composition comprises about 75% EPDM and about 25% thermoplastic elastomer. The thermoplastic elastomer preferably is saturated, and more preferably has a level of saturation of about 90% to less than about 100%.

These thermoplastic elastomers are two-phase systems. One of the phases is what is characterized as a hard polymer and the other phase is a soft rubbery polymer. In the block copolymers, the two phases are formed from segments of the same chain molecule. The simplest arrangement is a three-block A-B-A structure (where A represents the hard plastic and B represents the soft clastomer).

In the polystyrene/elastomer block copolymer, three main types of elastomer segments are commonly used commercially: polyisoprene, polybutadiene, and poly(ethylene-cobutylene). The product will be written as SIS, SBS, and SEBS respectively. The SEBS block copolymer is the only one in the family that has a completely saturated backbone (100% saturation), providing for optimum weatherability. It is however, a more costly rubber than EPDM and exhibits less tack.

Compared to SIS however, the level of initial tack achievable for a SEBS pressure sensitive adhesive is relatively poor even with an isoprene modified version SEBIS. The weak point of all thermoplastic rubber based adhesives is their sensitivity to lose their holding power (shear strength) at elevated temperatures.

Various other examples of rubbers that have a very good weathering resistance include silicones, hydrogenated nitrile rubbers (HNBR), propylene oxide polymers, epichlorohydrin polymers, chlorinated polyethylene, hypalon, polyacrylic rubbers, fluorocarbon elastomers, phosphonitrilic fluoroelastomers. Each of these and others may be used in the adhesive composition of this invention. However, most of them are much more costly than EPDM and are not as easily formulated as pressure-sensitive adhesives. Preferably, these additional examples of rubbers and others, are used in combination with at least one of the rubber polymers or thermoplastic elastomers described above to form the adhesive composition.

In addition to the rubber polymers and thermoplastic elastomers described as components of the adhesive composition above, the adhesive composition may further include any one of or a combination of tackifying resins, plasticizers, vulcanizing agents, stabilizers and/or other additives. Each of these additional components is well known to those skilled in the art of rubber compounding. However, some examples are provided herein.

For example, fully hydrogenated tackifying resins (such as Escorez® 5000 (Exxon Mobil Chemical Co., Baton Rouge La.) or Regalrez® 1000 (Hercules Incorporated, Wilmington Del.)), plasticizers (such as Paraflex HT 68 (Petro-Canada, Calgary Alta)) white mineral oil or Indopol® H-100 (BP Amoco, Charlotte N.C.) polybutene)), sulfur-donor vulcanizing agents (such as TMTD (tetramethyl thiuram disulfide (Akrochem Co., Akron Ohio)) or Zetax® (zinc 2-mercaptobenzothiazole (R. T. Vanderbilt Co. Inc., Norwalk Conn.)), stabilizers (such as Irganox® B215, Tinuvin® P, Tinuvin® 770(Ciba Specialty Chemical Corp., Tarrytown N.Y.)) may be added to the adhesive composition.

The amount of resins and or plasticizers used in the adhesive composition may be selected to alter the physical properties of the adhesive composition, including level of tack (initial grab) of the adhesive. For example, very high levels of resin and or plasticizers may result in an adhesive composition having excellent initial tack, but lower adhesion properties such as peel resistance and holding power.

The type of resin and/or plasticizer is preferably selected to be fully hydrogenated to avoid yellowing and premature failure of the adhesive.

The amount and/or type of stabilizers used in the adhesive composition may be selected to prevent the premature degradation of the adhesive during processing (mixing, extrusion and calendering) and optimize the intrinsic weathering resistance of the adhesive.

Example 1. An exemplary adhesive composition may have the following formulations, as shown in Table 1. The quantities are expressed in phr (parts per hundred of rubber), as measures used by those skilled in the art:

TABLE 1

| Adhesive | Rubber | Tackifying | Plasti- | Sulfur-Donor | |
|---|---|---|---|---|---|
| Compo- | Polymer | Resins | cizer | Agents | Stabilizers |
| sition | (phr) | (phr) | (phr) | (phr) | (phr) |
| A | EPDM 100 | 50-250 | 0-100 | 0-5 | 0-5 |
| B | EPDM 20-80 | 50-250 | 0-100 | 0-5 | 0-5 |
| | PIB 80-20 | | | | |
| C | EPDM 20-80 | 50-250 | 0-100 | 0-5 | 0-5 |
| | Butyl 80-20 | | | | |
| D | EPDM 20-80 | 50-250 | 0-100 | 0-5 | 0-5 |
| | SEBS 80-20 | | | | |

Tables A and B below represent additional exemplary adhesive formulations. For, instance, Table A is an example of a SEBS formulation and in Table B, an exemplary formulation for an adhesive formulation made in accordance with the teachings of the present invention.

TABLE A
Exemplary formulation of the SEBS adhesive.

| INGREDIENT | PHR | WEIGHT % |
|---|---|---|
| Kraton G1657 | 35 | 12 |
| Kraton GRP 6919 | 30 | 10 |
| Kraton G1650 | 35 | 12 |
| Regalite R91 | 145 | 50 |
| Regalite 1018 | 15 | 5 |
| Paraflex HT 68 | 25 | 10 |
| Irganox B215 | 1 | 0.4 |
| Tinuvin P | 1 | 0.3 |
| Tinuvin 770 | 1 | 0.3 |
| TOTAL | 288 | 100 |

TABLE B
Exemplary formulation of the EPDM adhesive.

| INGREDIENT | PHR | WEIGHT % |
|---|---|---|
| Royalene 301T | 62 | 22 |
| Royalene X-4070 | 20 | 7 |
| Kraton G-1650 | 18 | 7 |
| Regalite R91 | 120 | 44 |
| Regalite 1018 | 14 | 5 |
| Paraflex HT 68 | 17 | 6.3 |
| Indopol H-100 | 20 | 7.3 |
| Irganox B215 | 2 | 0.8 |
| Tinuvin P | 1 | 0.4 |
| Tinuvin 770 | 1 | 0.2 |
| TOTAL | 275 | 100 |

Adhesive Tape

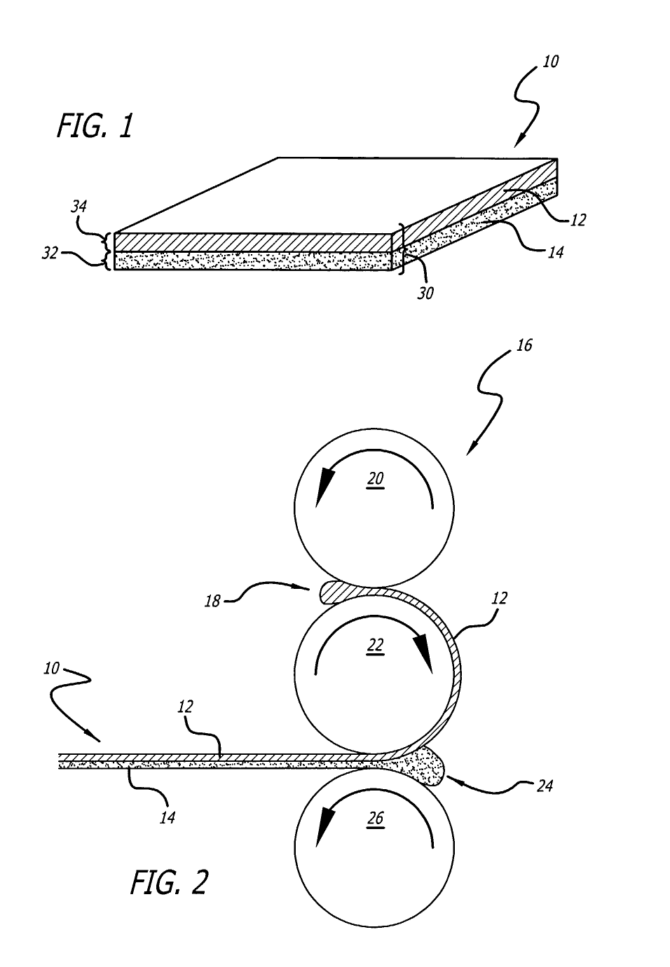

The adhesive composition described above can be used in the formation of a tape having at least one backing layer 12 and one adhesive layer 12 (of the adhesive composition) adhered thereto (FIG. 1). Preferably the tape is substantially transparent and/or translucent, and preferably the adhesive and backing are transparent and/or translucent. Further, the tape is preferably colorless, although may contain dyes in the adhesive or backing layer that render the tape colored. The tape preferably does not contain non-translucent or non-transparent agents, including, but not limited to, carbon black.

Materials which may suitable for use for the backing layer 12 of the tape 10 include, but are not limited to plastics, such as soft low-density polyethylene (LDPE, ex. Novapol® LE-0220-A (Nova Chemicals, Calgary Alta)), ethylene based copolymers such as ethylene methyl acrylate (EMA) or ethylene vinyl acetate (EVA) and their blends. Additives as known to those skilled in the art might be added to optimize the performance of the tape backing, For instance, concentrates from Ampacet Corp. (Tarrytown N.Y.) can be used, such as wax concentrates, anti-oxidant concentrates, and UV concentrates, for example. An exemplary formulation of LDPE tape backing is provided in Table C. This exemplary backing was utilized during tests comparing various characteristics of adhesive formulations in actual tapes, as discussed in greater detail below.

TABLE C
Formulation of an exemplary LDPE tape backing used with
exemplary SEBS and EPDM adhesives.

| INGREDIENT | DESCRIPTION | WEIGHT % |
|---|---|---|
| LDPE | Base resin | 98. |
| Ampacet 10057 UV | UV Concentrate | 1.0 |
| Ampacet 807236 | AO Concentrate | 0.8 |
| Ampacet 10433 | Process wax Concentrate | 0.2 |
| | TOTAL | 100 |

Preferably, the tape will have the following physical properties: clear (transparent), good initial grab (tack); high adhesion (for example, about 60 oz/in of peel adhesion to steel), pliable and conformable to irregular surfaces, good holding power (shear strength) and excellent UV durability. The thickness of the tape is preferably selected so that the tape product is thick enough to adequately adhere to the desired surface, yet thin enough to be useful in UV sensitive applications and/or maintain translucency or transparency. The dimensions described provide a useful “thin tape” product which is desirable commercially over existing thick tape products which are commercially available for outdoor use, but not preferable for UV sensitive applications due to adhesive thickness, polymer composition and/or lack of transparency or translucency. Preferably, the tape will have a tape thickness 30 of about 3 to about 20 mils, and more preferably about 7-9 mils. The adhesive layer of the tape will preferably have an adhesive thickness 32 of about 1 to about 10 mils, and more preferably about 2-4 mils. The backing layer of the tape will preferably have a backing layer thickness 34 of about 2-10 mils, and more preferably 3-5 mils.

As is known in the art, the materials selected for the backing layer 12 and/or adhesive layer 14 may be selected to achieve the above stated properties or to accomplish new properties depending upon the intended use of the tape. If needed for example, the composition of the backing layer may include various copolymers in order to increase the flexibility, to provide tapes that conforms better to the surface upon which they will be applied.

Method of Manufacture

As mentioned above, a tape 10 having a backing layer 12 and a rubber polymer adhesive layer 14 may be formed in one step using a calendering process. In this process the adhesive is extruded and coated directly onto a substrate formed on a calender. One advantage of this method is that no solvent is needed in the coating process and is more economical than other methods of manufacture which do require the use of solvents, or result in the creation of waste material, for example. The formation of the backing layer affords further economic advantage over preformed backings used in solution based coating methods.

In one method of manufacture, the adhesive tape 10 is manufactured using a one-pass calendering process whereby the backing layer 12 is formed directly on the calender.

In one embodiment of this method, the tape calendering process may employ a three-roll vertical calender 16 as shown in FIG. 2. Generally, the method of manufacturing an adhesive tape comprises the steps of: a) extruding a backing layer composition to a first nip between a top roll and a center roll to form a backing layer; b) feeding the backing layer to a second nip; c) extruding an adhesive composition at the second nip between the center roll and a bottom roll, such that an adhesive layer is applied on a surface of the backing layer to form an adhesive tape.

By way of example, an initial step for making the adhesive tape 10 may involve blending from about 95-100% of a low density polyethylene (LDPE), and from about 0 to about 5% of additives to form a molten LPDE composition.

The adhesive composition can be initially admixed before calendering by conventional means using conventional rubber compounding equipment such as an internal mixer, a two-roll rubber mill, a twin screw extruder or combinations thereof. The ingredients may be admixed at the elevated temperatures, for example ranging from about 120° F. (49° C.) to about 325° F. (163° C.). In one example, a Banbury® mixer is used at a temperature of about 300° F. (149° C.).

The exemplary molten LPDE composition may be extruded at an elevated temperature, for example about 380° F. (193° C.) to a first nip 18 between the top roll 20 and the center roll 22 by a single screw extruder. The top roll 20 may be maintained at an elevated temperature, for example, of about 380° F. (193° C.), and the center roll 22 may be maintained at a lower temperature, for example, of about 180° F. (82° C.).

Further, a backing layer 12 may then be formed from the LDPE composition on the center roll 22. The thickness of the backing layer 12 can be controlled by the gap (distance) between the top roll 20 and the center roll 22. The backing layer 12 may then be coated with an adhesive layer 14. The molten adhesive may be extruded at an elevated temperature, for example, about 290° F. (143° C.) and fed to the second nip 24 between the center roll 22 and the bottom roll 26 by a single screw extrusion. The bottom roll 26 may be maintained at an elevated temperature, for example of about 310° F. (154° C.). The thickness of the adhesive layer 12 is therefore controlled by a the gap between the center roll 22 and the bottom roll 26. The calendered adhesive tape 10 may then be cooled by means of cooling cans at a reduced temperature (at or below room temperature) and wound on a roll ready for converting. Alternatively, the adhesive composition may be calendered onto a preferred backing layer.

According to the teachings of the present invention, an exemplary EPDM containing adhesive was formulated and compared to other adhesive formulations in order to demonstrate the improved performance characteristics afforded by exemplary adhesive formulations and constructions under various testing conditions. One such exemplary formulation, having a polymer with a substantially saturated backbone component, is provided in Table B. This formulation, as well as the SEBS based adhesive formulation of Table A and a SIS containing adhesive, when disposed upon the exemplary backing formulation of Table C, provides tests results exemplified in Tables E, F and G. In addition to these three tape constructions, a fourth acrylic adhesive tape widely used for greenhouse repair (Patco PolyPatch II from Tyco Adhesives (Norwood, Mass.)) was included in the comparison tests. Various properties of the four test tapes are provided in Table D.

TABLE D
Basic properties of the various tapes.

| | | | | | ROLLING | ADHESION |
|---|---|---|---|---|---|---|
| | THICKNESS (mils) | | TENSILE | ELONGATION | BALL | TO STEEL |
| TAPE | BACKING | ADHESIVE | (lb/in) | (%) | TACK (in) | (oz/in) |
| SIS | 6.1 | 3.1 | 22 | 90 | 0.5 | 103 |
| ACRYLIC | 4.7 | 1.4 | 12 | >400 (no break) | 2.1 | 46 |
| SEBS | 7.2 | 3.0 | 26 | 68 | 1.1 | 60 |
| EPDM | 7.0 | 2.8 | 28 | 60 | 0.3 | 69 |

Outdoor weathering tests of the various tapes was carried out on greenhouse film (Super Dura-Film® 4 (AT Plastics Inc., Brampton ON)) having a thickness of about 6 mils. This is a widely utilized, plain polyethylene film for greenhouses. The clear tapes had their adhesive sides exposed to sun, through the greenhouse film, in order to approximate/simulate a greenhouse patch placed onto the polyethylene film from an interior side of a greenhouse, for example. A special rack inclined at 45° and facing South is used on the plant building roof (longitude=75.7 degrees West and latitude=45.4 degrees). 180-degree peel tests were then conducted on the film. Initial adhesion values are obtained after 1 day of conditioning in the lab (conditioning comprises applying the particular tape to the film at ambient room conditions (ex. room temperature and humidity). The results are summarized in Table E and demonstrate that the exemplary adhesive containing EPDM displays superlative adhesion to the Plastics Super Dura-Film® 4 (AT Plastics Inc., Brampton ON) in comparison to the other tapes, particularly over the long run. For example, at 19 days and 45 days, the exemplary EPDM containing adhesive tape displays superior adhesion to the greenhouse film when compared to the other tapes, particularly the acrylic and SIS containing adhesives, as shown in Table E.

TABLE E

| | ADHESION TO GREENHOUSE FILM | | | | | |
|---|---|---|---|---|---|---|
| | AFTER WEATHERING (oz/in) | | | | | |
| | | 1 | 3 | 7 | 19 | 45 |
| TAPE | INITIAL | DAY | DAYS | DAYS | DAYS | DAYS |
| SIS | 54 | 50 | 73 | 78 | 39* | 9** |
| ACRYLIC | 12 | 15 | 17 | 17 | 14 | 16 |
| SEBS | 31 | 22 | 48 | 39 | 65 | 61 |
| EPDM | 28 | 16 | 41 | 52 | 85 | 73 |

*Adhesive transferred on film.
**Tack totally lost

Similarly, outdoor weathering tests of the various tapes shows a continuation of this trend of the exemplary EPDM containing adhesive tape when the tapes are disposed upon Super Dura-Therm® 4, a higher grade of polyethylene film typically utilized in greenhouses and having a thickness of about 6 mils. Furthermore, this film has anti-condensate+light diffusing additives which may effect the tapes' adhesive chemistry and characteristics. The test tapes are exposed to sun on adhesive side first, through greenhouse film to simulate a greenhouse patch applied from the interior of a greenhouse. Again, 180-degree peel tests were conducted on the film. The initial values were obtained after 1 day of conditioning in the lab.

As can be seen in Table F, over the long run, the exemplary adhesive formulations of the present invention, here utilizing EPDM, maintain its adhesive qualities in comparison to other adhesives. For example, after 45 days of exposure, the exemplary EPDM containing adhesive tape still displays good adhesion and retains its tack whereas at the same time the SIS adhesive has very low tack.

TABLE F

| | ADHESION TO GREENHOUSE FILM | | | | | |
|---|---|---|---|---|---|---|
| | AFTER WEATHERING (oz/in) | | | | | |
| | | 1 | 3 | 7 | 19 | 45 |
| TAPE | INITIAL | DAY | DAYS | DAYS | DAYS | DAYS |
| SIS | 31 | 13 | 50 | 68 | 80 | 54* |
| ACRYLIC | 15 | 18 | 18 | 18 | 15 | 14 |
| SEBS | 17 | 12 | 23 | 32 | 39 | 53 |
| EPDM | 14 | 17 | 31 | 38 | 41 | 57 |

*Very low tack left

In another weathering test, the tapes were mounted on glass panels exposed to the sun in order to conduct comparative evaluation of light resistance performance of various tapes. The respective tape backings were directly facing the sun for all cases (SIS, acrylic adhesive, SEBS, EPDM adhesives). As shown in Table G, the SIS formulation suffered a delamination failure after only 3 weeks of exposure. The acrylic adhesive tape suffered a cohesive split of 10% after three weeks, escalating to cohesive failure after 10 weeks of exposure. Tape containing SEBS transferred the adhesive to the glass substrate after 15 weeks. In contrast, tapes having an exemplary adhesive formulations made in accordance with the teachings of the present invention (comprised of at least one polymer having a substantially saturated backbone, for example EPDM) maintained satisfactory cohesion and adhesiveness to the glass even after 15 weeks of exposure.

TABLE G

| | TAPE CONDITION WHEN ADHERED TO GLASS AFTER WEATHERING | | | | |
|---|---|---|---|---|---|
| TAPE | INITIAL | 3 WEEKS | 6 WEEKS | 10 WEEKS | 15 WEEKS |
| SIS | Ok | Delamination Failure | — | — | — |
| ACRYLIC | Ok | 10% cohesive split | 30% cohesive split | Cohesive failure | Cohesive failure |
| SEBS | Ok | Ok | Ok | Ok | Adhesive transfer |
| | | | | | to glass |
| EPDM | Ok | Ok | Ok | Ok | Ok |

As discussed above, adhesive formulations, as well as tape constructions, made in accordance with the teachings of the present invention, not only display superior UV resistance but also provide compositions having heat resistant properties. Tape samples (having the exemplary backing and adhesives formulations detailed previously) were subjected to heat aging in a circulating oven for about 4 days at about 150 degrees centigrade. The tapes are mounted on microscope glass slides and stainless steel panels.

On the glass substrate, the SIS adhesive became dry and turned brown (an indication of severe degradation). The acrylic adhesive tape displays cohesive split (a first stage of degradation). Both SEBS and EPDM adhesives remained clear and adhered to the glass.

Upon stainless steel, the SIS adhesive once again is totally dry and turns brown (a sign of severe degradation). Tape with the acrylic adhesive becomes totally dry. As a result of the high temperatures utilized during these tests, (150 centigrade), the backing material of the tape would at times shrink away from the underlying adhesive, thus exposing the adhesive directly to the air where it once was covered by the backing material. When this happens to the tape having the SEBS adhesive, the adhesive becomes dry and yellow. The exemplary EPDM containing adhesive, made according to the teachings of the invention, was the only one of the four adhesive formulations to display no color change and remains active (not dry and remains clear, flexible and can be cleanly peeled off) at day 4 and even day 5. The other adhesives degraded and suffered from oxidation, making them dry and brittle, the acrylic adhesive tape becoming brown and brittle by day 5.

While the specification describes particular embodiments of the present invention, those of ordinary skill can devise variations of the present invention without departing from the inventive concept. Other applications of the composition/constructions made in accordance with the teachings of the present invention may comprise automotive applications such as weather strips, decorative products, and uses within engine compartments , such as cable harnessing, for example. As discussed previously, the novel formulations and constructions of the present invention provide not only superior heat and UV resistance but also resistance to oxidation (ozone, for example) rendering them particularly useful for areas or on structures where electric arcs may be encountered, such as electric motors. Use on aircraft is also contemplated both for interior and exterior usage (ex. protection of propeller blade edge with abrasion resistant polyurethane backing). The teachings of the present invention may also be used to provide tapes useful in construction projects such as stucco masking, seaming vapor barrier membranes and various flooring installation applications.

While the teachings of the present invention have been particularly described in terms of tape constructions, the invention is by no means so limited. The invention further provides compositions that may be utilized upon a number of substrates and are not limited to being disposed upon backing layer for tapes. The composition may be disposed upon or form a substrate made of various material and of various sizes. The invention provides compositions that may be a laminating component and/or layer itself and/or for disposing films and/or coatings onto areas of various sizes/shapes, such as windows utilized in automotive vehicles and building structures, for example, in a sandwich-type construction (substrate-adhesive-substrate). The composition may also be provided as a self-supported film, as known to those of ordinary skill in the art. That is, the composition may be disposed (for example, calendered, extruded, etc) upon a release substrate, such as wax or silicone paper, for application upon desired substrates (for example, glass, plastics, polymers, masonry, metals, etc).

Additional uses include tarpaulin repair as well as general securing uses such as packaging tape, the application of signs on pavement and/or walls (indoor and out). The adhesives and constructions taught herein may be particularly useful for the application and securing of indicia, such as advertisements, on various vehicles such as cars, trucks, buses and the like. Further uses include the electrical field, such as for wire splicing, temporary protection during printed circuits manufacture and the sealing of junction boxes.

The adhesives and constructions may also be utilized in the medical arts, as tapes made according to the invention's teachings are latex-free and may be used for latex-free applications (to avoid potentially allergic reactions, for example). The invention also includes methods for applying the compositions taught herein to surfaces/substrates requiring protection from heat and/or UV and/or oxidative degradation. Such surfaces/substrates are not limited to being transparent or translucent.

The adhesives taught herein may also be utilized to provide radiation resistant polyethylene tape (for nuclear/medicinal purposes) as well as in office settings (long life library tape, affixing name plates upon walls or doors, etc) in addition to general uses such as packaging.

We claim:

1. A UV and heat resistant pressure sensitive adhesive product having a backing layer and an adhesive layer adhered thereto, wherein the adhesive layer includes at least one polymer having a substantially saturated backbone and the polymer being heat and UV resistant and the adhesive being pressure sensitive.

2. The product of claim 1, wherein the at least one polymer having a substantially saturated backbone comprises at least about 15% of the adhesive layer.

3. The product of claim 1, wherein the at least one polymer having a substantially saturated backbone comprises at least about 50% of the adhesive layer.

4. The product of claim 1, wherein the at least one polymer having a substantially saturated backbone comprises at least about 75% of the adhesive layer.

5. The product of claim 1, wherein the adhesive layer comprises about 50 to about 100% EPDM.

6. The product of claim 5, wherein the EPDM is at least about 98 to about 100% saturated.

7. The product of claim 1, wherein the adhesive layer comprises about 20 to about 80 percent EPDM and about 80 to 20 percent of butyl rubber.

8. The product of claim 1, wherein the adhesive layer comprises about 20 to about 80 percent EPDM and about 80 to 20 percent polyisobutylene.

9. The product of claim 1, wherein the adhesive layer comprises about 75% EPDM and about 25% polyisobutylene.

10. The product of claim 8 or 9, wherein the polyisobutylene is not fully saturated.

11. The product of claim 1, wherein said adhesive layer comprises about 20 to about 80% rubber polymer and about 20 to about 80% thermoplastic elastomer.

12. The product of claim 1, wherein the adhesive layer comprises about 75% EPDM and about 25% thermoplastic elastomer.

13. The product of claim 11 or 12, wherein the thermoplastic elastomer is not fully saturated.

14. The product of claim 1, wherein the adhesive layer is transparent or translucent.

15. The product of claim 10, wherein the backing layer is transparent or translucent.

16. The product of claim 1, wherein the adhesive composition further comprises tackifying resins, plasticizers, sulfur-donor vulcanizing agents, stabilizers and additives.

17. The product of claim 15, wherein the adhesive composition comprises about 100 per hundred rubber polymer, about 50-250 per hundred rubber tackifying resins, about 0-100 per hundred rubber plasticizer, about 0-5 per hundred rubber sulfur-donor vulcanizing agents and about 0-5 phr stabilizers.

18. A UV resistant adhesive tape comprising:
a) an adhesive layer wherein the adhesive is transparent or translucent and wherein the adhesive includes at least about 50% EPDM; and
b) a backing layer being transparent or translucent.

19. The adhesive tape of claim 1 or 18 having a tape thickness of about 3-20 mils.

20. The adhesive tape of claim 1 or 18 having an adhesive thickness of about 1 to about 10 mils.

21. The adhesive tape of claim 1 or 18 having a backing layer thickness of about 2 to about 10 mils.

22. The method of manufacturing an adhesive tape comprising the step of extruding an adhesive composition extrudate at an interface between a bottom roll and a middle roll onto a preformed backing layer to form an adhesive tape.

23. The method of manufacturing an adhesive tape comprising the step of extruding an adhesive composition extrudate at an interface between a bottom roll and a middle roll onto a preformed backing layer to form an adhesive tape, wherein the adhesive layer is comprised of at least one polymer having a substantially saturated backbone.

24. The method of manufacturing an adhesive tape comprising the steps of:
a) extruding a backing layer composition to a first nip between a top roll and a center roll to form a backing layer;
b) feeding the backing layer to a second nip;
c) extruding an adhesive composition at the second nip between the center roll and a bottom roll, such that an adhesive layer is applied on a surface of the backing layer to form an adhesive tape.

25. The method of manufacturing an adhesive tape comprising the steps of:
a) extruding a backing layer composition to a first nip between a top roll and a center roll to form a backing layer;
b) feeding the backing layer to a second nip;
c) extruding an adhesive composition at the second nip between the center roll and a bottom roll, such that an adhesive layer is applied on a surface of the backing layer to form an adhesive tape, wherein the adhesive layer is comprised of at least one polymer having a substantially saturated backbone.

26. An adhesive tape produced by the method of claim 22, 23, 24 or 25.

27. An article comprising:
pressure sensitive adhesive comprised of at least one polymer having a substantially saturated backbone;
a substrate upon which said pressure sensitive adhesive is disposed; and
a second substrate disposed upon the pressure sensitive adhesive.

28. The article of claim 27, wherein the at least one polymer having a substantially saturated backbone comprises at least about 15% of the adhesive layer.

29. The article of claim 27, wherein the at least one polymer having a substantially saturated backbone comprises at least about 50% of the adhesive layer.

30. The article claim 27, wherein the at least one polymer having a substantially saturated backbone comprises at least about 75% of the adhesive layer.

31. The article of claim 27, wherein the adhesive layer comprises about 50 to about 100% EPDM.

32. The article of claim 31, wherein the EPDM is at least about 98 to about 100% saturated.

33. The article of claim 27, wherein the adhesive layer comprises about 20 to about 80 percent EPDM and about 80 to 20 percent of butyl rubber.

34. The article of claim 27, wherein the adhesive layer comprises about 20 to about 80 percent EPDM and about 80 to 20 percent polyisobutylene.

35. The article of claim 27, wherein the adhesive layer comprises about 75% EPDM and about 25% polyisobutylene.

36. The adhesive tape of claim 34 or 35, wherein the polyisobutylene is not fully saturated.

37. The article of claim 27, wherein said adhesive layer comprises about 20 to about 80% rubber polymer and about 20 to about 80% thermoplastic elastomer.

38. The article of claim 27, wherein the adhesive layer comprises about 75% EPDM and about 25% thermoplastic elastomer.

39. The article of claim 37 or 38, wherein the thermoplastic elastomer is not fully saturated.

40. The article of claim 27, wherein the adhesive layer is transparent or translucent.

41. The article of claim 27, wherein said first substrate is transparent or translucent.

42. The article of claim 27, wherein said first substrate and said second substrate are transparent or translucent.

43. The adhesive tape of claim 27, wherein the adhesive composition further comprises tackifying resins, plasticizers, sulfur-donor vulcanizing agents, stabilizers and additives.
